(19) United States
(12) Patent Application Publication
(10) Pub. No.: US 2007/0016581 A1
(43) Pub. Date: Jan. 18, 2007

(54) Category setting support method and apparatus

(75) Inventors: Daigo Inoue, Kawasaki (JP); Kanji Uchino, Kawasaki (JP); Hiroya Inakoshi, Kawasaki (JP); Hirokazu Hanno, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/247,803

(22) Filed: Oct. 11, 2005

(30) Foreign Application Priority Data
Jul. 13, 2005 (JP) 2005-204192

(51) Int. Cl. G06F 7/00

(52) U.S. Cl. 707/7

(57) ABSTRACT

A category setting support method according to this invention includes calculating an influence degree to carry out a category setting to a data item for each of a plurality of data items stored in a data storage based on a predetermined relevant item, and storing the influence degree into the data storage in association with the corresponding data item; and determining a category setting priority order for each data item based on the influence degrees stored in the data storage, and displaying a display to carry out the category setting based on the category setting priority order. Accordingly, it becomes possible for a user such as a system administrator to efficiently set a category to the data item.

### TECHNICAL FIELD OF THE INVENTION

This invention relates to a technique for supporting a user to set a category for data.

### BACKGROUND OF THE INVENTION

Currently, the Internet is becoming a social infrastructure, and various information is being sent on it. Therefore, categorization and arrangement of the information are very important for the user to easily reach desired information, and for an information provider to appropriately provide necessary information for the user. Conventionally, although there is an information categorization technique based on a rule base and a machine learning, it is indispensable to maintain the rules in the rule base, and create correct answer data, which is a basis of the machine learning in order to operate the system. Besides, in order to identify the category by comparing with the correct answer data having accuracy of 100%, it is dispensable to expand the correct answer data. However, because the creation of the correct answer data is manually carried out by a system administrator, the cost becomes very expensive.

In addition, in a case where the information is product information, a tremendous amount of new product information is added every day, and it is impossible to create the correct answer data corresponding to the added product information within a limited period outside of the service time. Furthermore, because the fashion of the product rapidly changes, there is a case where the correct answer data becomes out of use soon, even if it was created. Accordingly, there are a lot of cases the work becomes useless.

Incidentally, U.S. Pat. No. 6,654,744 discloses a technique to heighten categorization accuracy regardless of contents and amount of information to be categorized. Specifically, it has a feature element extraction unit that extracts feature elements for each category from each of a plurality of sample text sets, which are included in a categorization sample data with which a sample text group and a plurality of categories are associated in advance, a categorization method determining unit that determines a categorization method having highest categorization accuracy among a plurality of categorization methods based on the categorization sample data, a categorization learning information generating unit that generates categorization learning information representing the feature for each category based on the feature elements extracted by the feature element extraction unit according to the categorization method determined by the categorization method determining unit, and an automatic categorization unit that categorizes new text groups to be categorized for each category according to the categorization method determined by the categorization method determining unit and the categorization learning information. However, this US patent does not take into account any correct answer data.

### SUMMARY OF THE INVENTION

As described above, although it is necessary to efficiently create the correct answer data, any investigation for this point is not carried out in the conventional technique. The correct answer data is obtained by directly setting a category to information to be categorized by the system administrator or the like.

Therefore, an object of this invention is to provide a technique enabling to efficiently set a category to data.

A category setting support method according to this invention is a category setting support method for supporting a category setting to a plurality of data items stored in a data storage, and includes calculating an influence degree of carrying out a category setting to a data item for each of a plurality of data items stored in the data storage based on a predetermined relevant item, and storing the influence degree into the data storage in association with the corresponding data item; and determining a category setting priority order for each data item based on the influence degrees stored in the data storage, and displaying a display to carry out the category setting based on the category setting priority order. Thus, it becomes possible for a user such as a system administrator to efficiently set a category to the data item.

In addition, the aforementioned influence degree may be determined based on a utilization frequency of the data item, and a future utilization degree of the correct answer data, which is obtained by carrying out the category setting to a data item and is used to carry out the category setting to another data item. Moreover, the utilization frequency of the data item may be calculated by at least one of an access amount of the data item, an access increased amount of the data item, which are specified by using data stored in an access log storage storing access logs for each data item, and the number of hit counts of the data item in a search engine provided on a network. It becomes possible to present a data item in a correct category to a reader of the data item by carrying out the category setting in an order of the data item having the higher utilization frequency. Furthermore, by carrying out the category setting in an order of the data item having the higher future utilization degree of the correct answer data to be created, it becomes easy to correctly and automatically carry out the category setting to another data item.

Furthermore, the aforementioned future utilization degree may be calculated by at least one of an appearance degree of nouns included in a specific attribute of the data item, and an index representing generality of nouns included in the specific attribute of the data item. For example, there is a case where a product name is composed of not only simple nouns, but also words and phrases like a catchphrase. In such a case, when paying attention to the noun, it is possible to heighten the influence degree of the data item including a product name that includes a lot of generic nouns with the high future utilization degree, as an attribute. Then, when referring to a database in which generic nouns are registered, it is possible to judge whether or not the noun included in the specific attribute of the data item is generic, and for example, the ratio of the generic nouns is used as the aforementioned index.

Moreover, the category setting support method may further include: carrying out an automatic judgment processing of the category for each data item, and storing the category name into the data storage in association with the data item. In such a case, the carrying out the automatic judgment processing includes carrying out a plurality of automatic judgment processings respectively having different confidence degrees for each data item, and storing the name of the firstly identified category into the data storage. In addition, the displaying may include displaying a result of the automatic judgment processing for each data item. The category setting priority order may be determined for each data item based on the influence degree and an index value according to a confidence degree of the automatic judgment processing by which the category of the data item was identified. By doing so, the user support for the system administrator or the like is carried out. Then, when causing the user to set the category in a descending order of the confidence degree, the setting efficiency is improved because the frequency the error is corrected is lowered.

A program causing a computer to execute the method according to this invention can be created, and the program is stored in a storage medium or storage device, such as a flexible disk, CD-ROM, magneto-optical disk, semiconductor memory, or hard disk. In addition, it may be distributed as digital signals via a network. Incidentally, intermediate data during processing is temporarily stored in a storage device such as a memory in a computer.

### BRIEF DESCRIPTION OF THE DRAWINGS

FIG. 1 is a functional diagram in an embodiment of this invention;

FIG. 2 is a diagram showing an example of a table representing the correspondence between a category code and a category name;

FIG. 3 is a diagram showing an example of data stored in a product data storage;

FIG. 4 is a diagram showing an example of data stored in a frequently appeared words DB;

FIG. 5 is a diagram showing an example of data stored in a product DB;

FIG. 6 is a diagram showing an example of data stored in a rule base DB;

FIG. 7 is a diagram showing an example of data stored in a categorization rule DB;

FIG. 8 is a diagram showing an example of data stored in a correct answer data DB;

FIG. 9 is a diagram showing a first portion of a main processing flow in the embodiment of this invention;

FIG. 10 is a diagram showing a second portion of the main processing flow in the embodiment of this invention;

FIG. 11 is a diagram showing an example of data stored in a categorized product data storage;

FIG. 12 is a diagram to explain a confidence degree of categorization methods or the like;

FIG. 13 is a diagram showing a third portion of the main processing flow in the embodiment of this invention;

FIG. 14 is a diagram showing a first portion of a processing flow of a ranking value calculation processing;

FIG. 15 is a diagram showing a second portion of the processing flow of the ranking value calculation processing;

FIG. 16 is a diagram showing an example of data stored in a ranking result storage;

FIG. 17 is a diagram showing a screen example presented to the user; and

FIG. 18 is a functional diagram of a computer.

### DETAILED DESCRIPTION OF THE PREFERRED EMBODIMENTS

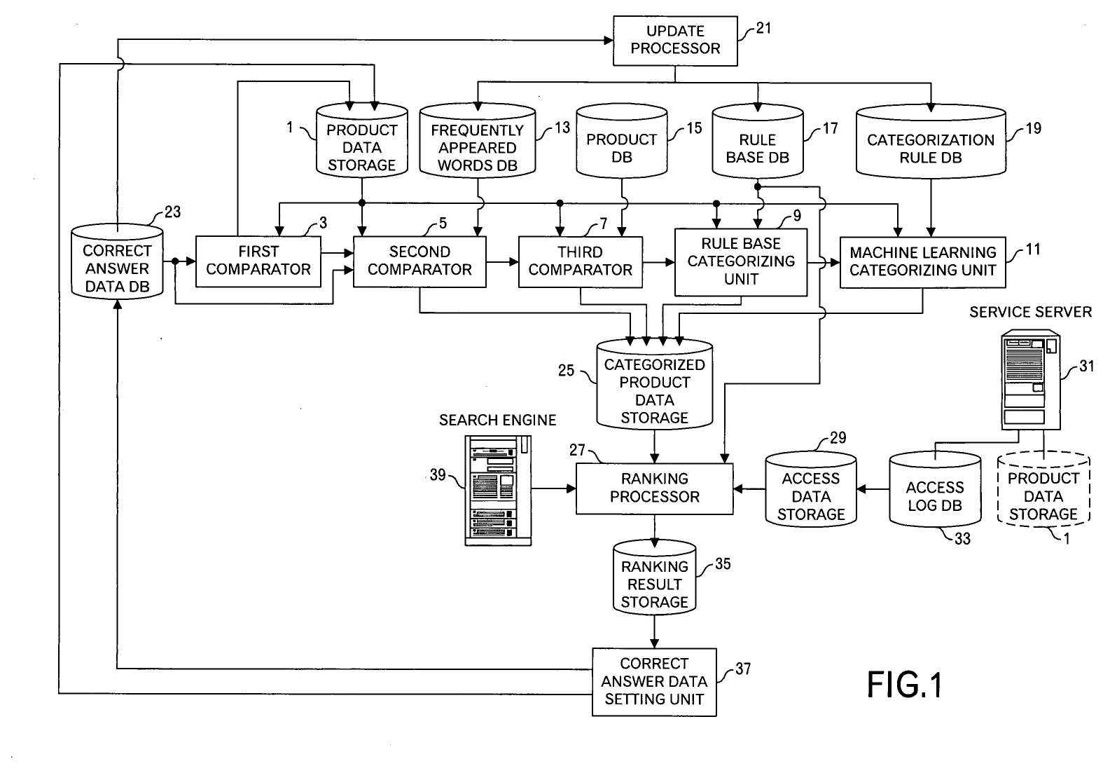

FIG. 1 shows a system outline according to one embodiment of this invention. In the following, a case where the data item to be categorized is product data will be explained. However, an applicable range of this invention is not limited to the product data.

A category setting support apparatus according to this embodiment is connected with a network such as the Internet, and includes a product data storage 1 for storing product data, a correct answer data DB 23 for storing data concerning pairs of a product name and a category code set by a user such as a system administrator, a first comparator 3 for carrying out a processing using data stored in the product data storage 1 and the correct answer data DB 23 in response to an instruction from the user such as the system administrator, a frequently appeared words DB 13 for storing data of words frequently appeared in all categories, a second comparator 5 for carrying out a processing using data stored in the product data storage 1 and the frequently appeared words DB 13 in response to an instruction from the first comparator 3, a product DB 15 for storing a manufacturer name and a model number of the product and a corresponding category code, a third comparator 7 for carrying out a processing using data stored in the product DB 15 and the product data storage 1 in response to an instruction from the second comparator 5, a rule base DB 16 for storing data of rules set by the system administrator or the like, a rule base categorizing unit 9 for carrying out a processing using data stored in the product data storage 1 and the rule base DB 17 in response to an instruction from the third comparator 7, a categorization rule DB 19 for storing data of categorization rules, which are results of the machine learning, a machine learning categorizing unit 11 for carrying out a processing using data stored in the product data storage 1 and the categorization rule DB 19 in response to an instruction or the like from the rule base categorizing unit 9, a user or the like, a categorized product data storage 25 for storing processing results by the first comparator 3, the second comparator 5, the third comparator 7, the rule base categorizing unit 9, or the machine learning categorizing unit 11, an access data storage 29 for storing access data extracted from an access log DB 33 storing access logs generated in response to accesses from outside to a service server 31, a ranking processor 27 for carrying out a processing using data stored in the categorized product data storage 25, the rule base DB 17, the access data storage 29 and the like, a ranking result storage 35 for storing processing results by the ranking processor 27, a correct answer data setting unit 37 for prompting the user to carry out a category setting by using data stored in the ranking result storage 35 and for carrying out an update processing for data stored in the product data storage 1 and the correct answer data DB 23 based on the set categories, and an update processor 21 for updating data stored in the frequently appeared words DB 13, the rule base DB 17 and the categorization rule DB 19. The ranking processor 27 is connected with the search engine 39 on the network such as the Internet, and can send it a search inquiry and receive the search result including the number of hit counts.

Incidentally, the service server 31 connected with the network such as the Internet transmits data stored in the product data storage 1 to a terminal requesting the data via the network, and generates and stores into the access log DB 33, the generated access log.

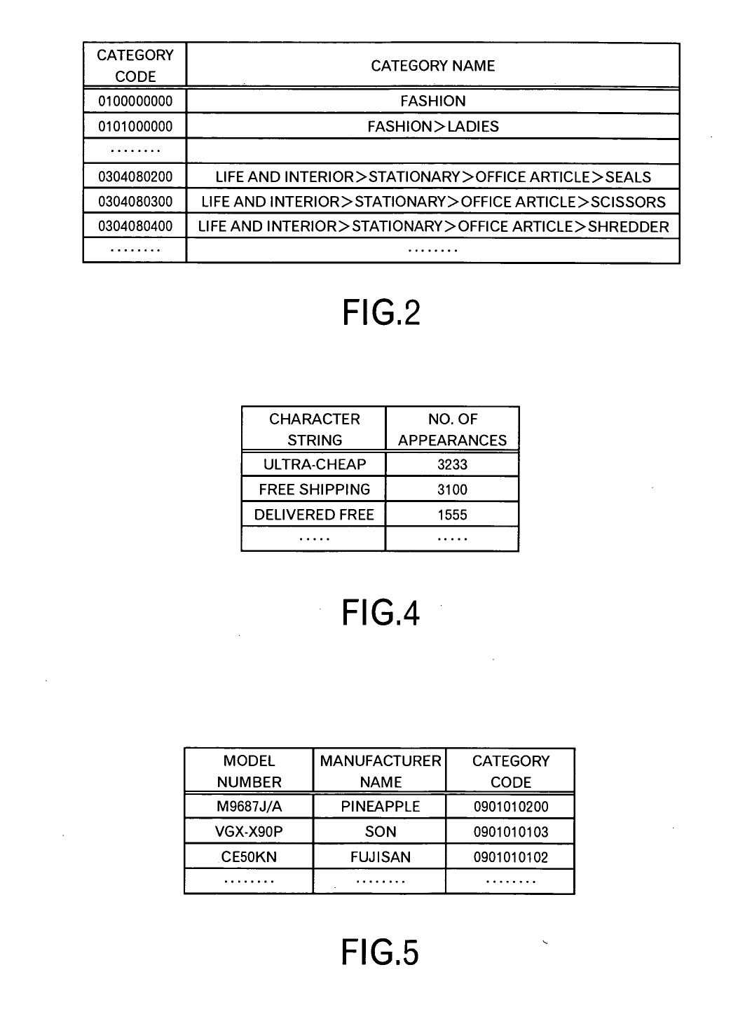

In addition, the category codes are defined in advance as shown in FIG. 2, and in the following processing, the category code as defined in FIG. 2 is assigned to the product data. In FIG. 2, a category name is associated with to a category code. The category code is configured hierarchically, and for example, “Fashion” and “Fashion>Ladies” have the common upper two digits of the category code. “Fashion>Ladies” in the lower level has different lower eight digits of the category code. Similarly, “Life and Interior>Stationary>Office Articles>Seals”, “Life and Interior>Stationary>Office Articles>Scissors” and “Life and Interior>Stationary>Office Articles>Shredder” has the common upper seven digits of the category code and different lower three digits each other.

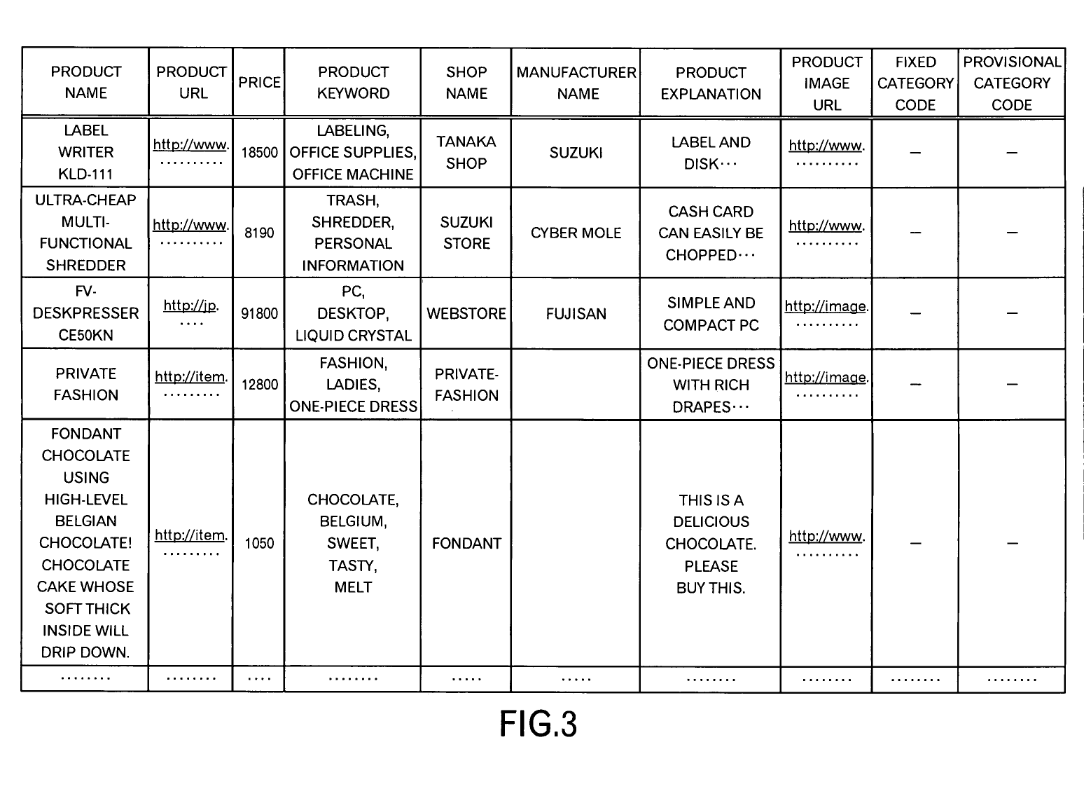

The product data storage 1 stores data as shown in FIG. 3, for example. In an example of FIG. 3, the product data storage 1 stores a product name, a product Uniform Resource Locator (URL), a price, product key words, a shop name, a manufacturer name, product explanation, a product image URL, a fixed category code and a provisional category code. As indicated in a column of the product name, the product name may include not only a simple product name, but also a product name such as a catchphrase, a model number, and a combination of the product name and the model number. In an example of FIG. 3, although the product data includes only the manufacturer name, the product data may include the model number.

The frequently appeared words DB 13 stores data as shown in FIG. 4, for example. In an example of FIG. 4, a table includes character strings of the frequently appeared words occurred in all categories, and the number of appearances. The frequently appeared words are not noticeable in the category setting, and are used to judge whether or not such words are used in the product name or not.

The product DB 15 stores data as shown in FIG. 5, for example. In an example of FIG. 5, a table stores a model number, a manufacturer name, a corresponding category code. In a case where both of the model number and the manufacturer name are identical with a pair of them for a product, or in a case where the model number is identical with the model number for a product, a corresponding category code is set to the product data of the product.

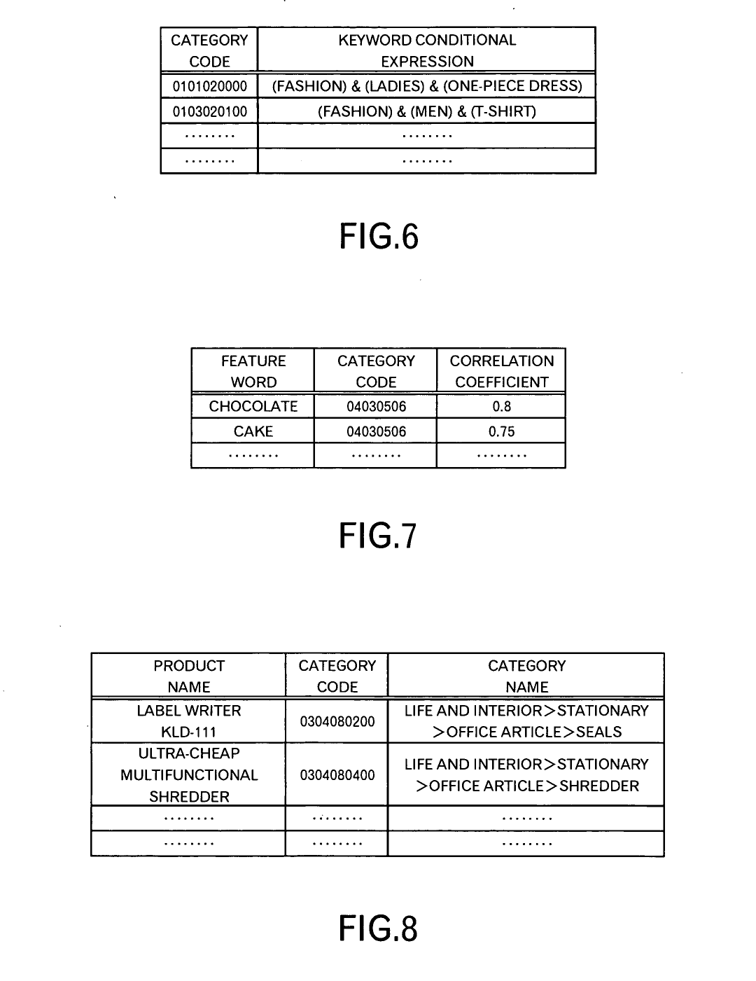

The rule base DB 17 stores data as shown in FIG. 6, for example. In an example of FIG. 6, a table stores a category code, and a keyword conditional expression (an expression using AND, OR, NOT and the like). The rule base categorization unit 9 judges whether or not the keyword conditional expression stored in the rule base DB 17 is satisfied, and sets a corresponding category code if the keyword conditional expression is satisfied.

The categorization rule DB 19 stores data as shown in FIG. 7, for example. In an example of FIG. 7, a table stores a feature word that does not appear in other categories, a category code and a correlation coefficient. The machine learning categorization unit 11 calculates an angle between product data and a category in a vector space from the feature word and the correlation coefficient stored in the rule base DB 19 and the like, and sets the category code with the smallest angle to that product data. Because such a processing conventionally exists, the further explanation is omitted.

The correct data DB 23 stores data as shown in FIG. 8, for example. In an example of FIG. 8, a table stores a product name, a category code, and a category name. The correct answer data is data in which the category code set by a system administrator or the like, the category name and the product name are associated, and because the correct answer data is set by the system administrator or the like, even the product name such as a catchphrase and the product name without discrimination can be registered.

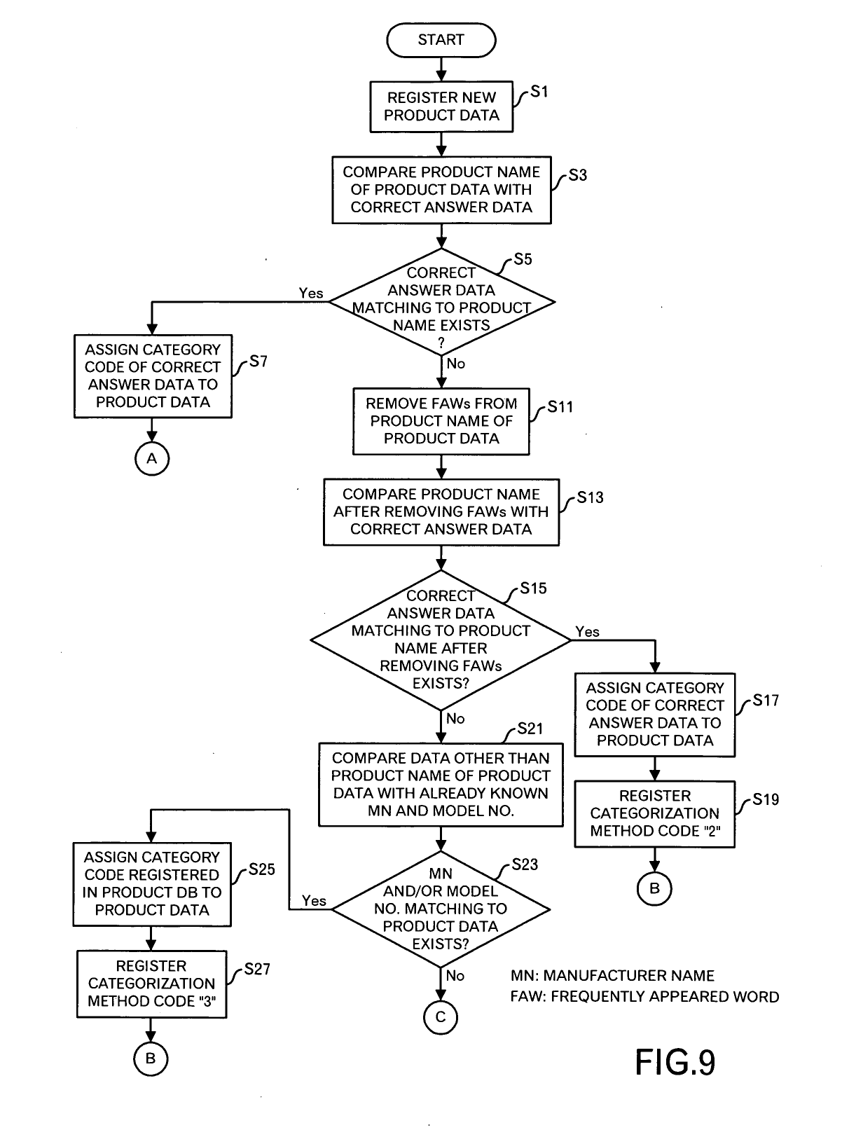

Next, a processing of the system shown in FIG. 1 will be explained using FIGS. 9 to 17. Firstly, product data for a new product is properly registered in the product data storage 1 together with the product data that has already been registered (step S1 in FIG. 9). However, at this stage, any fixed category code and provisional category code have not been registered. Next, the first comparator 3 compares the product name of the product data with the product name of the correct answer data by searching the correct answer data DB 23 for each product name of the product data stored in the product data storage 1 (step S3). Incidentally, there is no need to carry out the step S3 and the subsequent steps for the product data to which the fixed category code has already been set. Then, it judges whether or not the product name of the product data coincides with either of the product names of the correct answer data (step S5). As for the product data that is judged to coincide, it sets a category code of that correct answer data to that product data (step S7). That is, it registers the category code of the correct answer data as the fixed category code in the product data storage 1. In a case of carrying out the step S3 for the product data to which the fixed category code has already been set, the same category code is also assigned at the step S7. This is because the corresponding correct answer data has already been generated in a case where the fixed category code has been registered. Then, the processing is ended through a terminal A.

On the other hand, as for the product data whose product name was judged not to coincide with any product name of the correct answer data, the first comparator 3 outputs a processing start instruction to the second comparator 5. In response to the processing start instruction from the first comparator 3, the second comparator 5 carries out a word analysis for the product name of the product data whose fixed category code has not been registered in the product data storage 1 and carries out a processing to remove words identical with the frequently appeared words registered in the frequently appeared words DB 13 (step S11). For example, in a case of “Ultra-cheap multifunctional shredder”, because “Ultra-cheap” has already been registered in the frequently appeared words DB 13, “Ultra-cheap” is removed. Therefore, at the step S11, “multifunctional shredder” is generated. Then, it searches the correct answer data DB 23 for the product name after removing the frequently appeared words to compare the product name after removing the frequently appeared words with the product data of the correct answer data. After that, it judges whether or not the product name after removing the frequently appeared words coincides with either product name of the correct answer data (step S15). It assigns the category code of the correct answer data to the product data whose the product name after removing the frequently appeared words was judged to coincide with the product name of that correct answer data (step S17). That is, it registers the product data including the category code of the correct answer data as the provisional category code into the categorized product data storage 25. In addition, it set a categorization method code “2” to that product data and registers the categorization method code into the categorized product data storage 25 (step S19). Then, the processing shifts to step S37 via a terminal B.

On the other hand, the second comparator 5 outputs a processing start instruction for the product data whose product name after removing the frequently appeared words is judged not to coincide with any product name of the correct answer data to the third comparator 7. In response to the processing start instruction from the second comparator 5, the third comparator 7 compares data other than the product name of the product data whose fixed category code has not been registered in the product data storage 1 and which has not been registered in the categorized product data storage 25 with the already known manufacturer names and model numbers stored in the product DB 15 (step S21). The model name may be included in the product name, and may be included in the product keyword or the product explanation.

Then, it judges whether or not the model number that is data other than the product name of the product data coincides with any model number of any records in the product DB 15, or whether or not the model number and the manufacturer name that are data other than the product name of the product data coincides with any model numbers and any manufacturer names of any records in the product DB 15 (step S23).

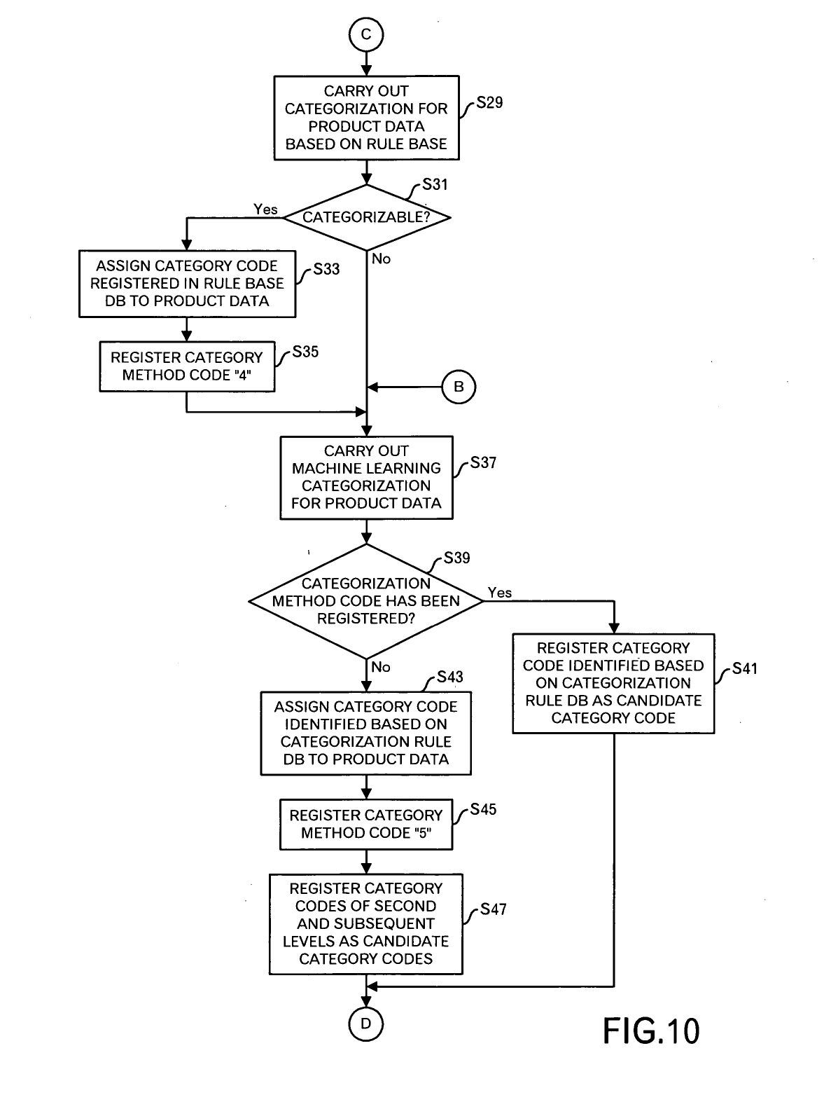

It assigns the category code of the record, which was judged to coincide, in the product DB 15 to the product data, which was judged to coincide, as the provisional category code (step S25). That is, it registers the product data including the category code obtained from the product DB 15 as the provisional category code into the categorized product data storage 25. In addition, it sets a categorization method code “3” to the product data, and registers the categorization method code into the categorized product data storage 25 (step S27). Then, the processing shifts to step S37 in FIG. 10 via the terminal B. In addition, in a case where data other than the product name of the product data was judged not to coincide with any model numbers or any manufacturers name and any model names, which are registered in the product DB 15, the processing shifts to step S29 in FIG. 10 via a terminal C.

The third comparator 7 outputs a processing start instruction to the rule base categorization unit 9. In response to the processing start instruction from the third comparator 7, the rule base categorization unit 9 applies the keyword conditional expressions stored in the rule base DB 17 to the product data whose fixed category code has not been registered in the product data storage 1 and which has not been registered in the categorized product data storage 25 (step S29: FIG. 10). To the product data, which can be categorized according to any keyword conditional expressions stored in the rule base DB 17 (step S31: Yes route), it assigned a category code corresponding to the keyword conditional expression that the product data satisfies and is registered in the rule base DB 17, as the provisional category code (step S33). That is, it registers the product data including the category code obtained from the rule base DB 17 as the provisional category code into the categorized product data storage 25. In addition, it sets a categorization method code “4” to the product data, and registers the categorization method code into the categorized product data storage (step S35). Then, the processing shifts to step S37.

On the other hand, a processing for the product data that does not satisfies any keyword conditional expressions registered in the rule base DB 17 shifts to step S37.

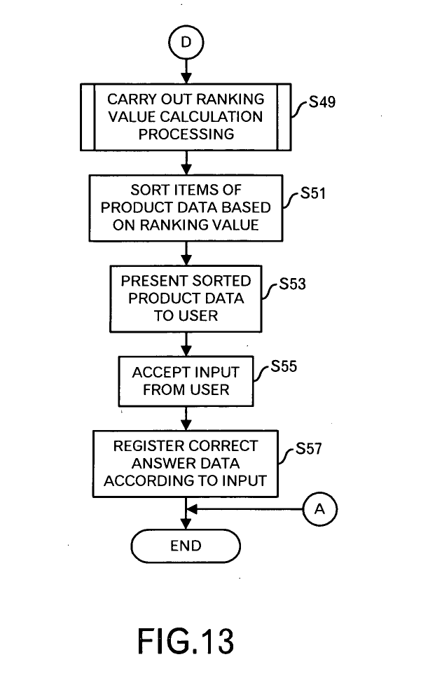

Next, the rule base categorization unit 9 outputs a processing start instruction to the machine learning categorizing unit 11. In response to the processing start instruction from the rule base categorization unit 9, the machine learning categorizing unit 11 carries out a well-known machine learning categorizing processing for the product data whose fixed category has not been registered in the product data storage 1 by using the data stored in the categorization rule DB 19 (step S37). In the machine learning categorizing processing, any category is always identified. Then, the machine learning categorizing unit 11 refers to the categorized product data storage 25 to register the category code identified based on the categorization rule DB 19 as a candidate category code for the product data to which the categorization method code has been registered (step S39: Yes route) into the categorized product data storage 25 (step S41). The candidate category code is used as an option for the system administrator or the like when the provisional category code cannot be used for the fixed category code, for example. Then, the processing shifts to a processing in FIG. 13 via a terminal D.

On the other hand, the machine learning categorizing unit 11 refers to the categorized product data storage 25 to register the category code identified based on the categorization rule DB 19 as the provisional category code for the product data whose categorization method code has not been registered (step S39: No route) into the categorized product data storage 25 (step S43). In addition, it sets a categorization method code “5” to the product data, and registers the categorization method code into the categorized product data storage 25 (step S45). Furthermore, it registers the category codes, which are identified based on the categorization rule DB 19 as the second and subsequent orders, as the candidate category codes into the categorized product data storage 25 (step S47). Then, the processing shifts to a processing in FIG. 13 via the terminal D.

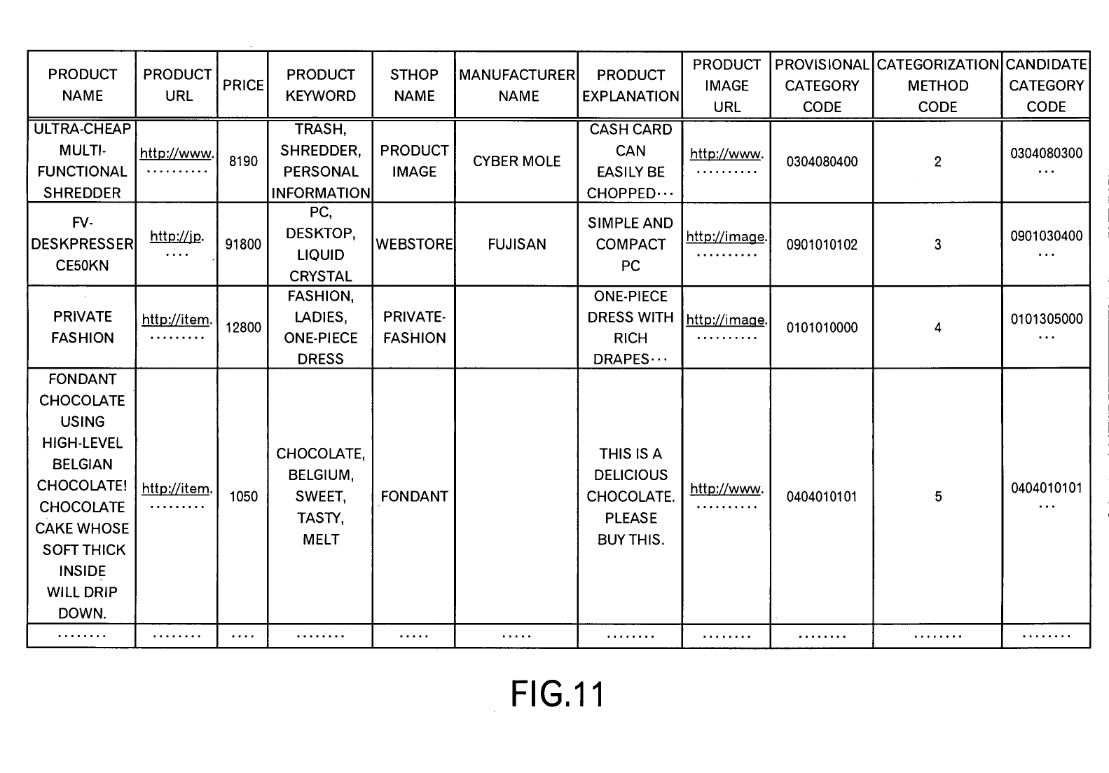

The data in the categorized product data storage 25, which was obtained by the aforementioned processing is data as shown in FIG. 11, for example. In an example of FIG. 11, a table stores a product name, a product URL, a price, product keywords, a shop name, a manufacturer name, product explanation, a product image URL, a provisional category code, a categorization method code, and candidate category codes. The difference with the product data storage 1 is that the provisional category code, the categorization method code and the candidate category codes are added. In the example of FIG. 11, the categorization method code for the first record is “2”, the categorization method code for the second record is “3”, the categorization method code for the third record is “4”, and the categorization method code for the fourth record is “5”. Incidentally, as for the product data whose the category code is identified by the correct answer data, its categorization method code is assumed as “1”.

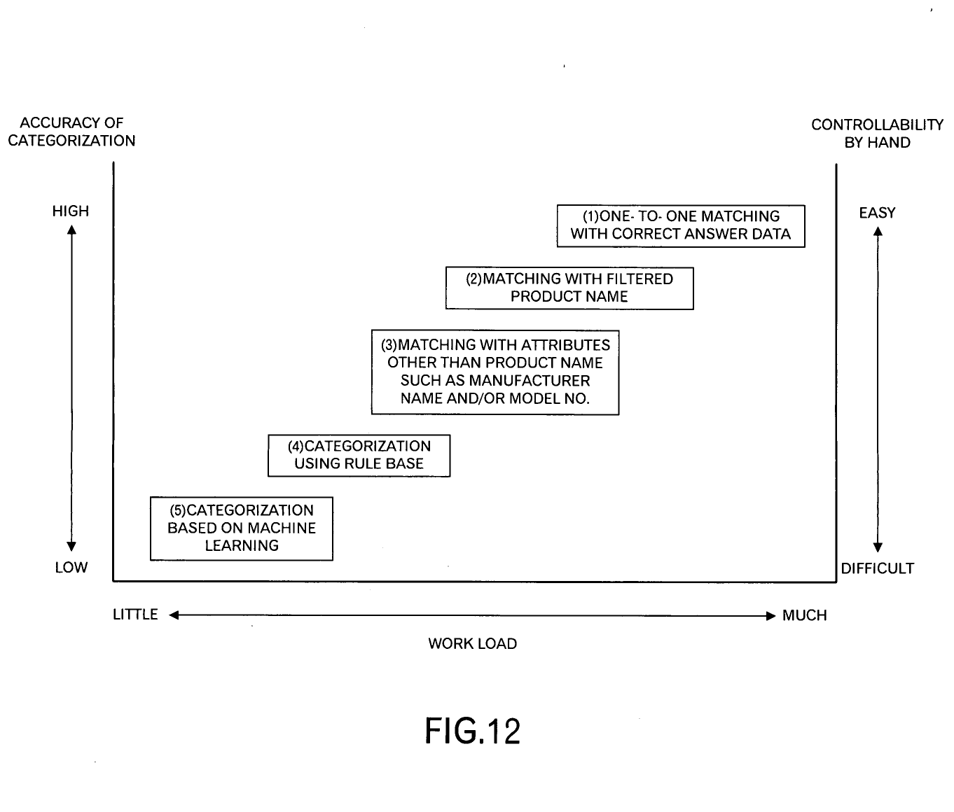

Generally, as shown in FIG. 12, the categorization method whose categorization method code has a smaller value has a higher categorization accuracy. In addition, the categorization method whose categorization method code has a smaller value has a higher controllability. On the other hand, the categorization method whose categorization method code has a larger value can reduce more trouble. In this embodiment, it is assumed that one-to-one comparison by the correct answer data is the most favorable categorization method. Therefore, a method necessary to efficiently set the correct answer data as large as possible will be explained below.

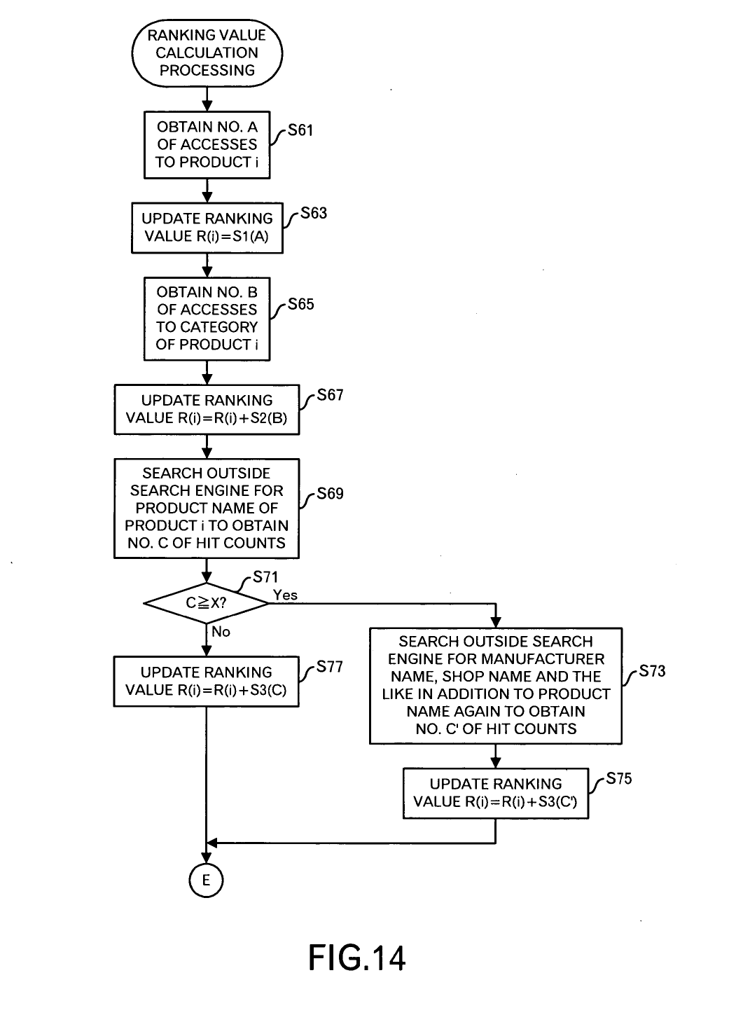

For the purpose, the ranking processor 27 carries out a ranking value calculation processing (step S49: FIG. 13). The ranking value calculation processing will be explained in detail using FIGS. 14 to 17. Incidentally, necessary data (for example, logs within a predetermined term. In a case where the access log DB 33 also includes logs other than logs concerning the accesses, only logs concerning the accesses are extracted, for example) of data stored in the access log DB 33 has to be stored in the access data storage 29. However, the ranking processor 27 may use the access log DB 33 itself.

The ranking processor 26 obtains the number A of accesses to a product i whose data is stored in the categorized product data storage 25 from the access data storage 29, and stores the number A into the ranking result storage 35 (step S61). For example, the number of access logs is counted for each product i within the predetermined term. The number of accesses is an index representing whether or not the product i is referenced well, that is, the whether product i attracts general users. When the number of accesses is large, the large influence is affected in a case where the category is wrong. In addition, when the number of accesses is large, it is predicted not only that the utilization frequency of the product data is high and but also that the possibility similar products will be registered is high and the utilization frequency of the correct answer data is also high. Then, it calculates the ranking value R(i)=S1(A) for each product i based on a predefined function S1 (step S63). The function S1 is a function that outputs a larger value according to A of the larger value.

Furthermore, the ranking processor 27 obtains the number B of accesses to a category (here, a provisional category) to which the product i registered in the categorized product data storage 25 belongs from the access data storage 29 and stores the number B into the ranking result storage 35 (step S65). For example, it identifies the category to which the product i belongs, from the categorized product data storage 25, and counts the number B of access logs based on the category code of the identified category in the predetermined term. For instance, it is possible to adopt such a configuration that the category code is identified from the URLs of the access destinations or the like, and the number of accesses is summarized using the configuration. This number of accesses also represents an attractive degree of the category including the product i to users. Then, based on a predefined function S2, it updates a ranking value R(i) for each product i by calculating R(i)=R(i)+S2(B) (step S67). The function S2 is a function that outputs a larger value according to B of a larger value.

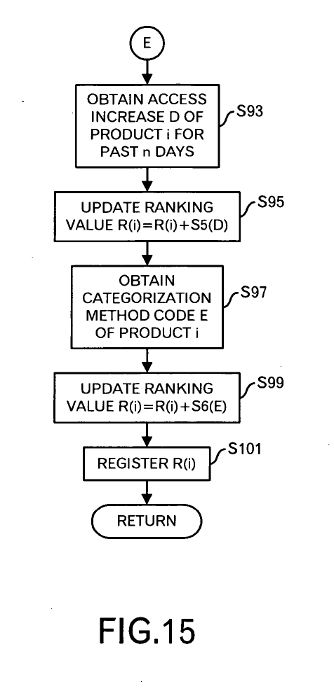

In addition, the ranking processor 27 searches the search engine 39 on the Internet, for example, for the product name of the product i, obtains the number C of hit counts, and stores the number C into the ranking result storage 35 (step S69). Then, it judges whether or not the number C of hit counts is equal to or larger than a threshold X (step S71). In a case where the product name is a general name, the number of hit counts is huge, and is inappropriate for the ranking value calculation. Therefore, the threshold X is provided. In a case where the number C of hit counts is equal to or larger than the threshold X (step S71: Yes route), it searches the search engine 39 for predefined attributes such as the manufacturer name and the shop name in addition to the product name again to obtain the number C′ of hit counts, and stores the number C′ into the ranking result storage 35 (step S73). The number of hit counts counted even either at the step S69 or at the step S73 reflects a coverage of the product name, and an attractive degree to general users, like the number of accesses. Then, it calculates R(i)=R(i)+S3 (C′) based on a predefined function S3 to update a ranking value R(i) for each product i (step S75). Then, the processing shifts to step S93 in FIG. 15. The function S3 is a function that outputs a larger value according to C of a larger value.

On the other hand, in a case where the number C of hit counts is smaller than the threshold X (step S71: No route), the ranking processor 27 calculates R(i)=R(i)+S3(C) based on the prefixed function S3 to update the ranking value R(i) for each product i (step S77). Then, the processing shifts to the step S93 in FIG. 15.

After the step S75 or step S77, the ranking processor 27 obtains an access increase D of the product i for the past n days by using the data stored in the access data storage 29, and stores the access increase D into the ranking result storage 35 (step S93). The access increase D is calculated as difference between the current access amount and access amount before n days. This access increase also represents the attractive degree of the product i to users. Then, it calculates R(i)=R(i)+S5(D) based on a predefined function S5, and updates the ranking value R(i) for each product i (step S95). The function S5 is also a function that outputs a larger value according to D of a larger value.

In addition, the ranking processor 27 obtains the categorization method code E of the product i from the categorized product data storage 25 (step S97). Then, it calculates R(i)=R(i)+S6(E) based on a predefined function S6, and updates the ranking value R(i) for each product i (step S99). As shown in FIG. 12, because when the value of the categorization method code is small, the confidence level of the categorization method is high, the function S6 is a function that outputs a larger value according to the categorization method code E of a smaller value. In this embodiment, high priority is set to the provisional category code having the high confidence level. Therefore, the working efficiency is improved by allowing the user such as the system administrator to set the provisional category code itself as the fixed category code as many as possible without spending much work load.

Then, the ranking processor 27 stores the ranking value R(i) of the product i, which was calculated at the step S99 into the ranking result storage 35 (step S101). Incidentally, the product data stored in the categorized product data storage 25 at any step of the processing flows in FIGS. 14 and 15 is also stored in the ranking result storage 35. The processing returns to the original processing.

By carrying out such a processing, the ranking value is calculated for each product i. It is considered that the ranking value represents an influence degree in which the correct answer data is generated for a specific product, that is, an influence degree in which the category is set to specific product data. When the ranking value has a large value, the effect to generate the correct answer, that is, to set the category to the product data is high. On the other hand, when the ranking value has a small value, the effect to generate the correct answer data, that is, to set the category to the product data is low. The effect includes an effect for general users who browse the product data, and an effect for the user such as the system administrator who generates the correct answer data, that is, sets the category to the product data. As for the former, it is understood that when the wrong category is set to the product data whose utilization frequency of the general users is high and to which the attention is paid (the product having the large value of the number of accesses, the number of hit counts on the search engine, and the access increase), the problem becomes large in view of the exposure degree. The latter relates to an influence degree in view of the future utilization degree representing that the work load is reduced by applying the generated correct answer data to other many products after the correct answer data was generated once. The appearance ratio of nouns and the ratio of nouns registered in the rule base represent the generality of the product name, and when the generality is high, the future utilization degree becomes high in the aforementioned view, and the correct answer data should be generated by priority. For the product name such as the proper noun having the low generality, there is no need to generate the correct answer data by priority.

Furthermore, in the embodiment, because the ranking value is updated based on the category method code, the ranking value is set according to the setting efficiency of the correct answer data and the aforementioned influence degree. As described above, because the correction probability by the user such as the system administrator is reduced more, when the accuracy of the category setting is higher, the setting efficiency becomes improved.

According to the ranking value calculated based on the aforementioned consideration, the priority to present the product data to the user such as the system administrator is determined.

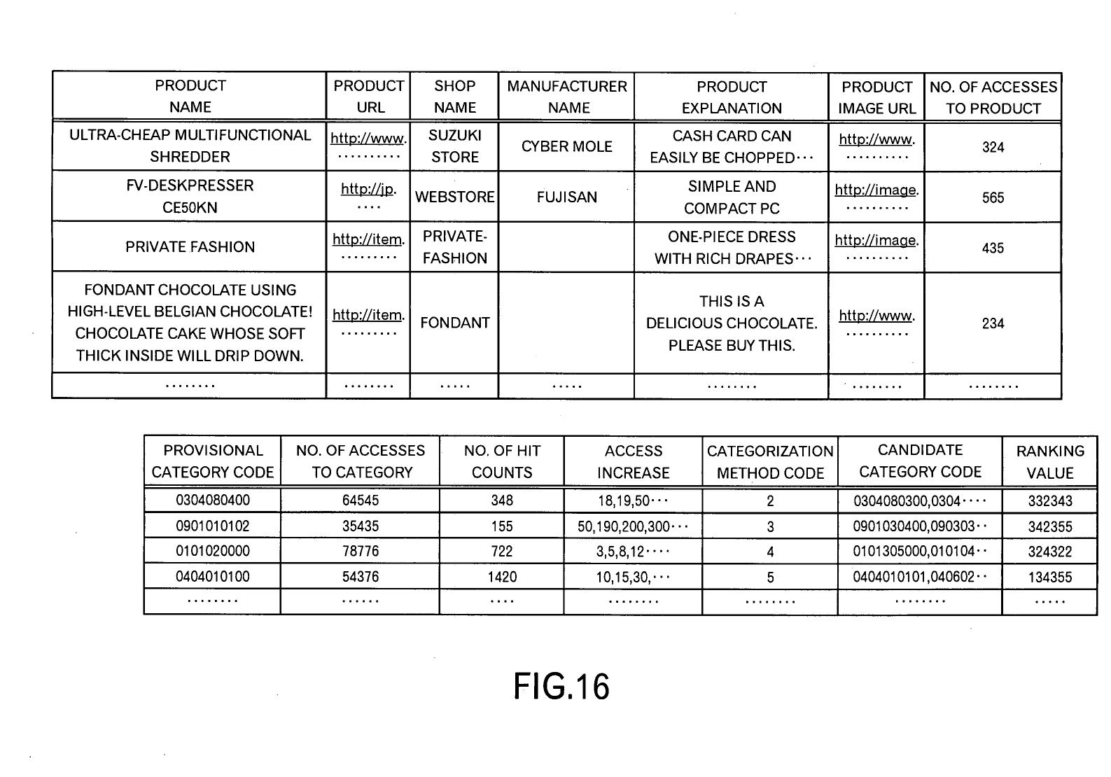

FIG. 16 shows an example of data stored in the ranking result storage 35. In an example of FIG. 16, in addition to the data stored in the categorized product data storage 25 shown in FIG. 11, the number of accesses to the product, the number of accesses to the category, the number of hit counts, the access increase and the ranking value are added.

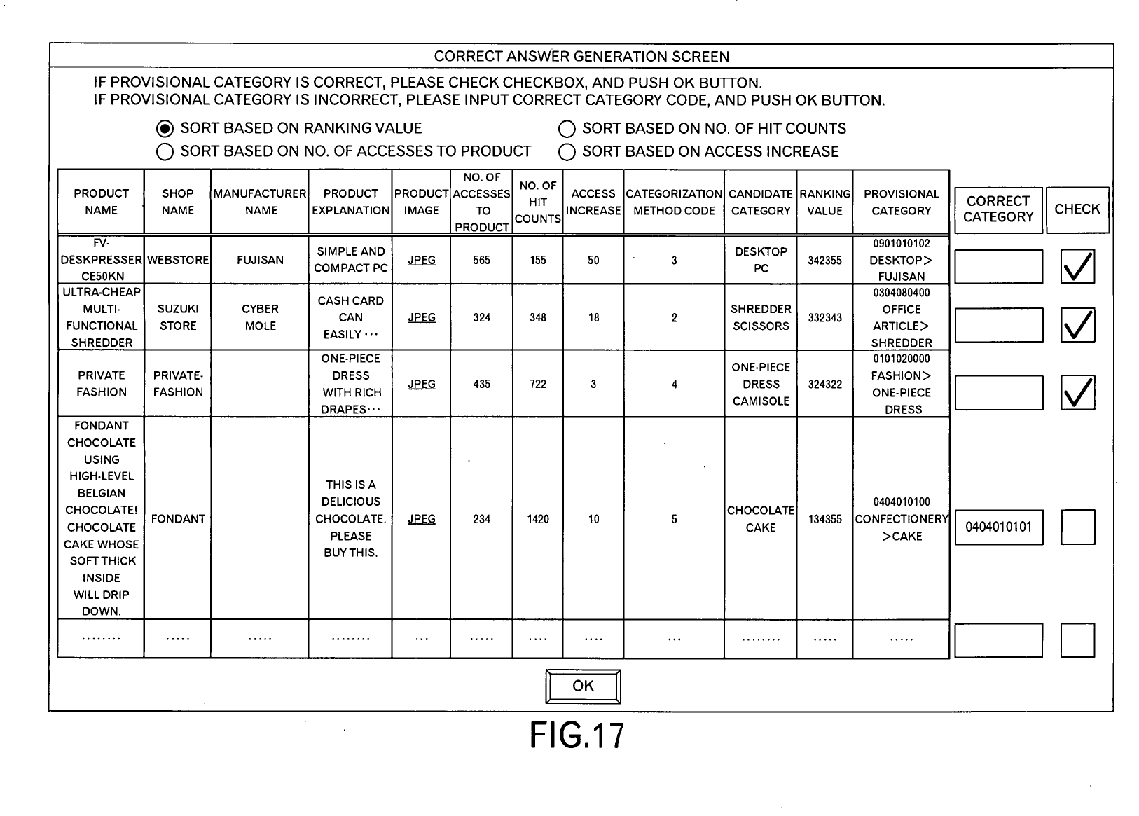

Returning to the explanation of FIG. 13, next, the correct answer data setting unit 37 sorts records stored in the ranking result storage 35 based on the ranking values and the like (when the user instructs, there is a case of the number of accesses to the product, the number of accesses to the category, the access increase or the like). Then, it generates display data to be presented to the user based on the sort result, and outputs the display data to the display apparatus (step S53). For example, a screen as shown in FIG. 17 is displayed. The screen of FIG. 17 includes radio buttons to select one of sorting based on the ranking value, sorting based on the number of hit counts, sorting based on the number of accesses to the product, and sorting based on the access increase, a table representing data stored in the ranking result storage 35, input columns to input the correct category code for each line of the table in a case where the provisional category is incorrect, check boxes to set a check for each line of the table in a case where the provisional category is correct, and an OK button to instruct to carry out the setting. The extraction of the category name from the category code can be carried out by using data shown in FIG. 2. The user such as the system administrator can carry out the rearrangement of the products by using the radio buttons, and confirms whether or not the provisional category code of the product data is correct, and sets a check to the check box of the product data when it is correct. When it is not correct, it is possible to refer to data of the candidate category, for example, and to input that code, and it is also possible to input the code of another category. In FIG. 17, although only an upper portion of the ranking value is indicated, it is possible to show the product data whose ranking value is lower by scrolling, and it is also possible to present the data by plural screens.

The correct answer data setting unit 37 accepts the input from the user (step S55), and stores a set of the product name and the category code for the product data to which the check was set in the check boxes or the product data to which the correct category code was input, into the correct answer data DB 23 according to the user input (step S57). Furthermore, as for the product data to which the check was set in the check boxes or the product data to which the correct category code was input, the provisional category code or inputted category code is registered as a fixed category code, and as for the product to which the check was not set in the check boxes, the provisional category code is registered as the provisional category code.

By carrying out the aforementioned processing, it is possible to present the product data to the user such as the system administrator in a form in which the priority order is assigned according to the ranking value. When the user sets the category codes according to the priority order, the user can carry out the work in a descending order of the influence degree by setting the category code and in a descending order of the work efficiency.

Although one embodiment of the invention was explained, this invention is not limited to this embodiment. For example, functional blocks shown in FIG. 1 do not always correspond to actual program modules. In addition, the screen configuration of FIG. 17 is mere one example, and the screen configuration is not limited to FIG. 17. Furthermore, it is possible to change the functions used in the calculation of the ranking value according to the data to be processed, appropriately. In addition, although the nouns registered in the rule base are indicated as examples of the general nouns, it is possible to prepare another data storage storing the general nouns.

Incidentally, the aforementioned category setting support apparatus may be a server connected with the service server 31 via the network, and may receive instructions from other terminals connected with the network, for example.

In addition, the update processor 21 uses data stored in the correct answer data DB 23 to carry out an update processing of the frequently appeared words DB 13, the rule base DB 17 and the categorization rule DB 19, periodically or at any arbitrary timing, for example. It extracts words, which are frequently appeared in the product names registered in the correct answer data DB 23 without biasing to any specific category, and stores them into the frequently appeared words DB 13. It carries out a processing to extract the keyword conditional expressions from the product names and category codes stored in the correct answer data DB 23, and stores them into the rule base DB 17. This processing is carried out according to an instruction from the user. In addition, it carries out the machine learning processing for the product names and category codes stored in the correct answer data DB 23, and stores processing results into the categorization rule DB 19.

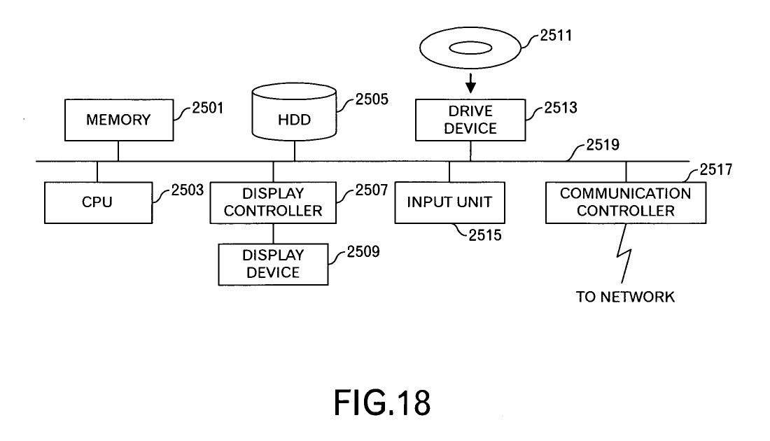

In addition, the category setting support apparatus is a computer device as shown in FIG. 18. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 28. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in details are realized.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A method for supporting a category setting to a plurality of data items stored in a data storage; comprising:
calculating an influence degree of carrying out a category setting to a data item for each of a plurality of data items stored in said data storage based on a predetermined relevant item, and storing the calculated influence degree into said data storage in association with the corresponding data item; and
determining a category setting priority order for each said data item based on said influence degrees stored in said data storage, and displaying a display to carry out said category setting based on said category setting priority order.

2. The method as set forth in claim 1, wherein said influence degree is determined based on a utilization frequency of said data item, and a future utilization degree of correct answer data, which is obtained by carrying out said category setting to said data item and is used to carry out said category setting to another data item.

3. The method as set forth in claim 2, wherein said utilization frequency of said data item is calculated by at least one of an access amount to said data item, an access increase to said data item, which are specified by using data stored in an access log storage storing access logs for each said data item, and a number of hit counts of said data item in a search engine provided on a network.

4. The method as set forth in claim 1 further comprising:
carrying out an automatic judgment processing of a category for each said data item, and storing a category code identified by said automatic judgment processing into said data storage in association with the corresponding data item.

5. The method as set forth in claim 4, wherein said carrying out said automatic judgment processing comprises carrying out a plurality of automatic judgment processings respectively having different confidence degrees, for each said data item, and storing the firstly identified category code into said data storage, and said determining and displaying comprises determining said category setting priority order for each said data item based on said influence degree and an index value according to a confidence degree of said automatic judgment processing by which a category of said data item is identified.

6. The method as set forth in claim 1, further comprising:
removing a data item whose category code is identified by a comparison with said correct answer data from among said data items stored in said data storage.

7. The method as set forth in claim 6, further comprising:
registering a code of an input category into said data storage in association with said data item to which said category is set by a user; and
registering a specific attribute of said data item to which said category is set by said user and said code of said input category as correct answer data into a correct answer data storage.

8. A program embodied on a medium, for supporting a category setting to a plurality of data items stored in a data storage; said program comprising:
calculating an influence degree of carrying out a category setting to a data item for each of a plurality of data items stored in said data storage based on a predetermined relevant item, and storing the calculated influence degree into said data storage in association with the corresponding data item; and
determining a category setting priority order for each said data item based on said influence degrees stored in said data storage, and displaying a display to carry out said category setting based on said category setting priority order.

9. The program as set forth in claim 8, wherein said influence degree is determined based on a utilization frequency of said data item, and a future utilization degree of correct answer data, which is obtained by carrying out said category setting to said data item and is used to carry out said category setting to another data item.

10. The program as set forth in claim 9, wherein said utilization frequency of said data item is calculated by at least one of an access amount to said data item, an access increase to said data item, which are specified by using data stored in an access log storage storing access logs for each said data item, and a number of hit counts of said data item in a search engine provided on a network.

11. The program as set forth in claim 8 further comprising:
carrying out an automatic judgment processing of a category for each said data item, and storing a category code identified by said automatic judgment processing into said data storage in association with the corresponding data item.

12. The program as set forth in claim 11, wherein said carrying out said automatic judgment processing comprises carrying out a plurality of automatic judgment processings respectively having different confidence degrees, for each said data item, and storing the firstly identified category code into said data storage, and said determining and displaying comprises determining said category setting priority order for each said data item based on said influence degree and an index value according to a confidence degree of said automatic judgment processing by which a category of said data item is identified.

13. The program as set forth in claim 8, further comprising:
removing a data item whose category code is identified by a comparison with said correct answer data from among said data items stored in said data storage.

14. An apparatus for supporting a category setting to a plurality of data items stored in a data storage; comprising:
a unit that calculates an influence degree of carrying out a category setting to a data item for each of a plurality of data items stored in said data storage based on a predetermined relevant item, and stores the calculated influence degree into said data storage in association with the corresponding data item; and
a display unit that determines a category setting priority order for each said data item based on said influence degrees stored in said data storage, and displays a display to carry out said category setting based on said category setting priority order.

15. The apparatus as set forth in claim 14, wherein said influence degree is determined based on a utilization frequency of said data item, and a future utilization degree of correct answer data, which is obtained by carrying out said category setting to said data item and is used to carry out said category setting to another data item.

16. The apparatus as set forth in claim 15, wherein said utilization frequency of said data item is calculated by at least one of an access amount to said data item, an access increase to said data item, which are specified by using data stored in an access log storage storing access logs for each said data item, and a number of hit counts of said data item in a search engine provided on a network.

17. The apparatus as set forth in claim 14, further comprising:
an automatic judgment unit that carries out an automatic judgment processing of a category for each said data item, and stores a category code identified by said automatic judgment processing into said data storage in association with the corresponding data item.

18. The apparatus as set forth in claim 17, wherein said automatic judgment unit comprises carrying out a plurality of automatic judgment processings respectively having different confidence degrees, for each said data item, and stores the firstly identified category code into said data storage, and said display unit determines said category setting priority order for each said data item based on said influence degree and an index value according to a confidence degree of said automatic judgment processing by which a category of said data item is identified.

19. The apparatus as set forth in claim 14, further comprising:
a unit that removes a data item whose category code is identified by a comparison with said correct answer data from among said data items stored in said data storage.

20. The apparatus as set forth in claim 19, further comprising:
a unit that registers a code of an input category into said data storage in association with said data item to which said category is set by a user; and
a unit that registers a specific attribute of said data item to which said category is set by said user and said code of said input category as correct answer data into a correct answer data storage.
